(19) United States
(12) Patent Application Publication
(10) Pub. No.: US 2024/0283798 A1
(43) Pub. Date: Aug. 22, 2024

(54) APPLYING A GROUP BASED POLICY TO NETWORK TRAFFIC FROM A CLIENT

(71) Applicant: HEWLETT PACKARD ENTERPRISE DEVELOPMENT LP, Spring, TX (US)

(72) Inventors: Balaji Sankaran, Bangalore (IN); Venkatavaradhan Devarajan, Bangalore (IN); Vinayak Joshi, Bangalore (IN)

(21) Appl. No.: 18/315,269

(22) Filed: May 10, 2023

(30) Foreign Application Priority Data
Feb. 16, 2023 (IN) 202341010475

(51) Int. Cl. H04L 9/40

(52) U.S. Cl. CPC H04L 63/104; H04L 63/102; H04L 63/30

(57) ABSTRACT

Some examples relate to a proxy service on a network device for applying a group based policy (GBP) to network traffic from a client. In an example, a proxy service on a network device is used to intercept a network access request message, pertaining to a client, from an access device. The proxy service forwards the network access request message to an authentication server. The server responds by sending a network access response message to the access device. The proxy service intercepts the network access response message from the authentication server and obtains the role information of the client from the network access response message. In response to receiving network traffic from the client, the proxy service identifies a GBP corresponding to the role information of the client and applies the GBP to the network traffic from the client.

### BACKGROUND

Virtual Extensible Local Area Network (VXLAN) is a network virtualization technology that uses an encapsulation technique to tunnel Layer 2 connections over an underlying Layer 3 network. VXLAN is used in data centers to create overlay networks that sit on top of a physical network, enabling the use of virtual networks.

### BRIEF DESCRIPTION OF THE DRAWINGS

For a better understanding of the solution, examples will now be described, with reference to the accompanying drawings, in which:

FIG. 1 is a block diagram of a computing environment that uses a proxy service to apply a group based policy to network traffic from a client, according to some examples;

FIG. 2 illustrates a network device, according to some examples;

FIG. 3 is a block diagram of a communication flow, according to some examples;

FIG. 4 is a flowchart of a method, according to some examples; and

FIG. 5 is a block diagram of a storage medium storing machine-readable instructions, according to some examples.

### DETAILED DESCRIPTION

Network virtualization and decoupling of the virtual network from the physical network makes it easier to manage, scale, and automate a network, for example, in a data center environment. Virtual Extensible Local Area Network (VXLAN) allows segmentation of networks whereby one could create up to 16 million VXLANs in an administrative domain.

VXLAN is an overlay technology. VXLAN creates virtual networks that are overlaid on a physical network. The underlay network is a physical Internet Protocol (IP) network. As mentioned earlier, a network could be segmented into multiple VXLANs. VXLAN network identifier (VNI), which is a 24-bit field in a VXLAN header, is used to uniquely identify a VXLAN. When a device sends network traffic that belongs to a VNI, a VXLAN enabled switch encapsulates the network traffic, for example, in IP headers. The network traffic is then sent across the underlay network (e.g., IP network) and when the packet reaches the destination switch, the packet is decapsulated. VXLAN endpoints, which terminate VXLAN tunnels and may be either virtual or physical switch ports, are referred as VXLAN tunnel endpoints (VTEPs).

Group Based Policies (GBP) are used to segment client traffic in a network by grouping clients into roles based on device authentication at the ingress switch (e.g., VTEPs). As used herein, the term “group based policy (GBP)” refers to a list of roles and resources with which roles are to be provisioned. A GBP can define permissions and duration of access to a device. A client can be Media Access Control (MAC) authenticated, or 802.1X authenticated. After authentication a Group Policy ID can be mapped to the client based on the role applied.

A GBP helps by providing segmentation of client traffic in the same domain based on a client's role (determined during authentication). In a VXLAN network, a GBP allows segmentation of client traffic based on client role. The role is converted into a Group Policy ID and carried in VXLAN header. At egress, the switch determines if the traffic from the source (as carried in the Group Policy ID) is permitted to the destination and accordingly either forwards or drops the traffic.

In an implementation, enforcement of a GBP does not happen for a client's onboarding via switches that do not support VXLAN and GBP enforcement. Switches use data path (e.g., application-specific integrated circuit (ASIC) support) for VXLAN onboarding and GBP policy enforcement. Lower end switches (e.g., some layer 2 switches) generally don't have these capabilities for reasons such as cost, hardware design, and resource constraints (e.g., processor or memory). Lower end switches do not support VXLAN features (e.g., switches may not support forwarding of encapsulated VXLAN packets through the underlying Layer 3 network) or network policy enforcement (e.g., GBP).

Similarly in a wireless network with controller-less deployments, GBP cannot be supported as policy enforcement of wireless clients occurs at the controller. In a wireless network with a controller, access points (APs) are managed by the controller. The controller provides an AP its configuration and functions as a router for the wireless traffic. The controller provides a consolidated management for the entire wireless network. In a controller-less deployment, a virtualized controller software is run on APs themselves. A separate physical controller is not used to manage the wireless network. These drawbacks make a GBP enforcement solution ineffective in network deployments that have a heterogeneous mix of switches (e.g., switches that do not support VXLAN and GBP policy enforcement) or wireless clients without a controller.

The proposed solution addresses these technical challenges by using a proxy service on a network device to apply a GBP(s) to network traffic from a client. In an example, a proxy service (e.g., a RADIUS proxy service) is deployed on a network device (e.g., an aggregation switch) to intercept a network access request message, pertaining to a client, from an access device (e.g., network switch or AP). The proxy service on the network device forwards the network access request message to an authentication server (e.g., RADIUS server). Once the authentication server receives the network access request packet, it can respond by sending a network access response message (including role information of the client) to the access device. The proxy service on the network device intercepts the network access response message from the authentication server and obtains the role information of the client from the network access response message. In future, in response to receiving network traffic from the client, the proxy service identifies a GBP corresponding to the role information of the client and applies the GBP to the network traffic from the client.

The proposed solution allows enforcement of GBP for clients (wired or wireless) across a network even if a client on-boards on a switch or access point that does not support GBP. Further, the proposed solution uses a common Anycast IP address on access switches or APs on a network (e.g., a VXLAN) to simplify authentication server (e.g., RADIUS server) configuration. As used herein, the term “Anycast IP” refers to an IP network addressing scheme that allows multiple devices to share the same IP address, allowing for multiple physical destination devices to be logically identified by a single IP address. In an example, the proxy service listens to network communication from a common Anycast IP address configured on access switches or APs to intercept messages, e.g., network access request message. Using a common Anycast IP address simplifies configuration of access switches and access points for supporting enforcement of GBP for wired or wireless clients.

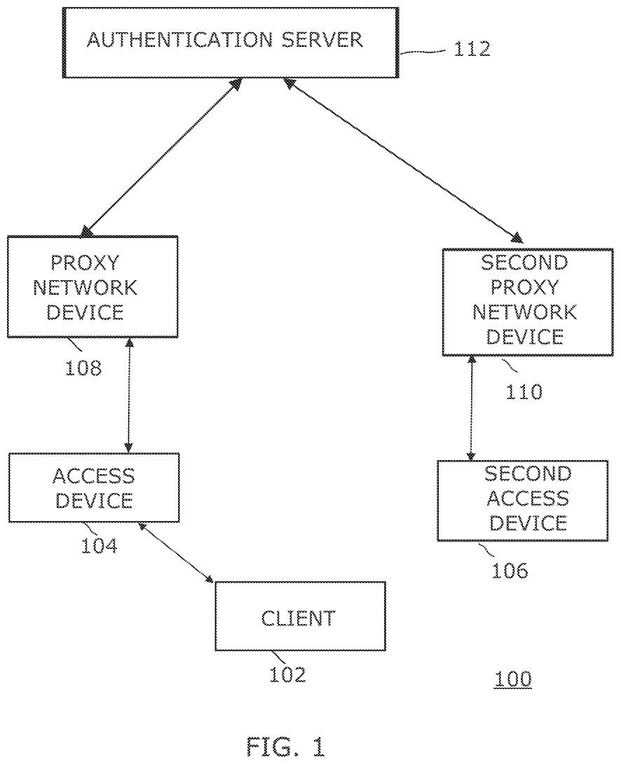

Referring now to the figures, FIG. 1 is a block diagram of an example computing environment 100 that includes a client 102, access devices (e.g., access device 104 and second access device 106), proxy network devices (e.g., proxy network device 108 and second proxy network device 110), and an authentication server 112. In the example of FIG. 1, one client 102, two access devices 104 and 106, two proxy network devices 108 and 110, and one authentication server 112 is depicted for simplicity. In some examples, computing environment 100 may include a different number of clients, access devices, proxy network devices, and authentication servers.

In some examples, the client 102, the access devices (e.g., access device 104 and second access device 106), proxy network devices (e.g., proxy network device 108 and second proxy network device 110), and the authentication server 112 can be communicatively coupled over a network such as a local area network (LAN), a VXLAN, wireless local area network (WLAN), a storage area network (SAN), a campus area network (CAN), the internet, or any other type of network. In some examples, the client 102, the access devices (e.g., access device 104 and second access device 106), the proxy network devices (e.g., proxy network device 108 and second proxy network device 110), and the authentication server 112 can be present in different geographical locations.

In an example, the client 102 attempts to connect to the network (e.g., LAN or WLAN) via the access device 104. As used herein, the term “client” can include an end physical device (e.g., a desktop computer, a notebook computer, a tablet computer, a thin client, a mobile device, or any other processing device) or software (machine-readable instructions) executable on a client device that is seeking connection, network, or data services from a network. As used herein, the term “access device” refers to a network device that facilitates the connection of end node devices (e.g., client 102) to a network. Examples of the access device 104 can include an access switch or an access point. The term “access switch” refers to a Layer 2 switch that can be used to connect to a network. The term “access point” refers to a wireless network device that acts as a portal for devices to connect to a network. In an example, the access device 104 can include lower end switches (e.g., layer 2 switches). In an example, the access device 104 is first authenticated in order to enable the access device 104 to exchange messages between the client 102 and the proxy network device 108. The client 102 (e.g., wireless client) first connects to the access device 104 (e.g., AP), and the access device 104 connects to the proxy network device 108 (e.g., switch).

In order to authorize the client's access to the network, an authentication mechanism is used. The authentication mechanism can be based on, for example, the 802.1X protocol or MAC authentication. 802.1X is a network authentication protocol that provides authentication for secure network access. The 802.1X protocol opens ports for network access when an organization authenticates a client 102 and authorizes the client 102 for access to the network. The client's identity can be determined based on, for example, the credentials (e.g., username and password) or certificate presented by the client 102, which is confirmed by the authentication server 112.

As used herein, the term “authentication server” refers to a device, software, or the like that facilitates the authentication of an entity that attempts to access a network. Such an entity may be a device or human user. An authentication server 112 can reside in, for example, a dedicated computer, a switch, a network cloud, or a network access server. In some examples, the authentication server 112 includes a Remote Authentication Dial-In User Service (RADIUS) server. The term “RADIUS” refers to a client-server protocol that enables a device (e.g., a server or a switch) to communicate with a central server (“RADIUS server”) to authenticate a client (“RADIUS client”) and authorize the client's access to a requested system or service.

The authentication server 112 acts as the security guard of the network. As a client 102 connects to the network, the authentication server 112 authenticates the client's identity and authorizes the client 102 for network use. A client 102 is authorized for network access after confirming its credentials or certificate. In an example, the authentication server 112 can confirm the client's identity by communicating with a directory maintained, for example, on a Lightweight Directory Access Protocol (LDAP) server that includes identification details for validating the client's identity.

For 802.1X authentication, the access device 104 can detect the client 102 and attempt to establish a connection. The detection can occur, for example, when the client 102 plugs-in through a cable to the access device 104 (e.g., a network switch) or connects wirelessly with the access device 104 (e.g., AP). The access device 104 creates a virtual port with the client 102 and invokes Extensible Authentication Protocol (EAP) to send an EAP request message to the client 102.

The EAP provides a secure method to send identifying information over-the-air for 802.1X network authentication. It provides an encrypted EAP tunnel that prevents outside users from intercepting information. In response to the EAP request message, the client 102 sends an EAP response message to the access device 104. The response can include identification details (e.g., credentials or certificate) of the client 102. The access device 104 receives the EAP response message.

The access device 104 maintains an IP address configuration for a proxy service on the proxy network device 108. As used herein, the term “proxy network device” refers to a network device that hosts a proxy service. The term “proxy service” refers to a component (e.g., software) that acts as an intermediary between an endpoint device (e.g., authentication sever) and a client 102 which is requesting a service or resource from the endpoint device. The proxy network device 108 can include a network switch (e.g., an aggregation switch), a network router, or any other network device. The term “aggregation switch” refers to a network switch that is used to aggregate the data of access switches and forward the data to a core switch. A core switch refers to a network switch that is positioned at the backbone or physical core of a network. In an example, the proxy network device 108 and the second proxy network device 110 are VTEPs in a VXLAN network.

In an example, the IP address configuration for the proxy service includes an Anycast IP address. As mentioned earlier, “Anycast IP” refers to an IP network addressing scheme that allows multiple devices to share the same IP address, allowing for multiple physical destination devices to be logically identified by a single IP address. Using Anycast, network traffic to a single IP address can be routed to multiple nodes (e.g., proxy network devices). In an example, both the access device 104 and the second access device 106 can include a common Anycast IP address configuration for the proxy service. Since both the access device 104 and the second access device 106 include a common Anycast IP address configuration for the proxy service, network traffic received form one or more clients on either the access device 104 or the second access device 106 is routed to the proxy service. The access device 104 can send a network access request message to the proxy network device 108 using the Anycast IP address. In an example, the network access request message is the EAP response message.

In some examples, the IP address (e.g., Anycast IP address) configuration on the access device 104 for the proxy service can be specific to the authentication mechanism used to authenticate the client 102. For example, separate IP addresses (e.g., Anycast IP addresses) can be configured for an 802.1X authentication based proxy service and a MAC authentication based proxy service, on the proxy network device 108.

The proxy service on the proxy network device 108 can intercept the network access request message from the access device 104. In an example, the proxy service on the proxy network device 108 listens to network communication from the Anycast IP address configured on the access device 104 to intercept messages (e.g., network access request message).

The proxy network device 108 maintains a mapping of the Anycast IP address to the authentication server 112 (e.g., RADIUS server). In some examples, if separate IP addresses (e.g., Anycast IP addresses) are configured on the access device 104 for different authentication mechanisms (802.1X authentication or MAC authentication), separate authentication servers can be mapped to the IP addresses. For example, for an 802.1X authentication based proxy service, a first Anycast IP address can be mapped to a first authentication server (e.g., a first RADIUS server). In another example, for a MAC authentication based proxy service, a second Anycast IP address can be mapped to a second authentication server (e.g., a second RADIUS server). In some examples, the proxy service on the proxy network device 108 can listen to two separate ports (one for each server).

The proxy service forwards the network access request message to the authentication server 112 (e.g., a RADIUS server). In an example, the network request message includes an EAP response message. Depending on the Anycast IP address that receives the network access request message, the proxy service mapped to the Anycast IP address forwards the message to the mapped authentication server 112. For example, for messages received on a first Anycast IP address, a corresponding 802.1X authentication based proxy service can forward the message to a first authentication server (e.g., a first RADIUS server). In another example, for messages received on a second Anycast IP address, a corresponding MAC authentication based proxy service can forward the message to a second authentication server (e.g., a second RADIUS server).

In an example, before the proxy service forwards the access request message from the access device 104, the access device 104 is first authenticated by the authentication server 112 using an authentication mechanism. The access device 104 is first authenticated in order to enable the access device 104 to exchange messages (e.g., network access request message) between the client 102 and the proxy network device 108. Since the client 102 (e.g., wireless client) first connects to the access device 104 (e.g., AP), and the access device 104 connects to the proxy network device 108 (e.g., switch), in deployments where security is of significance, the access device 104 is authenticated so that the access device 104 can be trusted. For example, in public avenue deployments (e.g., stadium or airport), for security reasons, it could be unsafe to grant an untrusted access device (e.g., 104) access to the network without authentication. Client traffic (e.g., from client 102) coming via the access device 104 is allowed after authentication of the access device 104. However, the authentication of the access device 104 could be optional. For example, in secure campus deployments, the access device (e.g., 104) may be trusted without authentication.

When the access device 104 is to be authenticated, the access device 104 could go through the same authentication mechanism as the client 102. The authentication mechanism for the access device 104 can be based on, for example, the 802.1X protocol or MAC authentication. In case of 802.1X authentication, the access device 104 sends an access request message to the proxy service on the proxy network device 108. In an example, the access request message is an EAP request message. Upon receiving the access request message, the proxy service forwards the access request message to the authentication server 112. In response to the access request message, the authentication server 112 sends an access response message. In an example, the access response message can include an EAP response message. In an example, if the EAP response message includes an EAP-Failure message, the proxy network device 108 denies the access request of the access device 104. If the access response message includes an EAP-Success message, the proxy network device 108 accepts the access request of the access device 104. In the latter case, the access device 104 is authenticated and allowed to exchange messages with the authentication server 112.

In response to network access request packet, the authentication server 112 can send a network access response message to the proxy service. In an example, the network access response message can include an EAP message. In an example, the EAP message can include an EAP-Failure message, which indicates that the authentication server 112 has rejected the network access request from the client 102. In another example, the network access response message can include an EAP-Success message, which indicates that the authentication server 112 has accepted the network access request from the client 102.

In an example, the network access response message can include role information of the client 102. As used herein, the term “role information” refers to a role assigned to a client 102 by the authentication server 112. The term “role” refers to the actions and activities assigned to or permitted for an entity (e.g., the client 102). Some non-limiting examples of a role can include a user-related role such as an employee, an intern, a guest, or a contingent worker. In an example, the role information can be pre-configured on the authentication server 112, for example, by a user (e.g. network administrator).

In an example, the role assigned to a client 102 is based on the identification details (e.g., credentials or certificate) provided by the client 102 to the authentication server 112 during the authentication process. For example, in the case of 802.1X-based authentication, the EAP response message from the client 102 to the access device 104 can include identification details (e.g., credentials) of the client 102.

In an example, the authentication server 112 can use the client's identification details (e.g., credentials (e.g., username and password) or certificate) to identify a user associated with the client 102 and, based on the user identification, assigns a role to the client 102. In an example, the authentication sever can refer to an organization's LDAP server that hosts, for example, user identities (e.g., employee, contingent worker, intern, etc.), usernames, passwords, or other user information to identify a role for the client 102. For example, if the credentials (e.g., credentials or certificate) identify the user associated with the client 102 as an employee, the authentication server 112 can assign a corresponding role to the client 102 and includes the role (e.g., employee) in the role information of the client 102. In another example, if the credentials (e.g., credentials or certificate) identify the user associated with the client 102 as a contingent worker, the authentication server 112 assigns a corresponding role to the client 102 and includes the role (e.g., contingent worker) in the role information. In an example, the role information can be pre-configured on the proxy network device 108, for example, by a user (e.g. network administrator).

The network access response message can also include a MAC address of the client 102. In an example, the proxy service obtains the role information and the MAC address of the client 102 from the network access response message. The proxy service then maps the MAC address of the client 102 to the role information of the client 102. In an example, the proxy service stores the mapping between the MAC address and the role information of the client 102 on the proxy network device 108.

The proxy service sends the network access response message, received from the authentication server 112, to the access device 104. In an example, the network access response message can include an EAP message. In an example, if the EAP message includes an EAP-Failure message, the access device 104 denies the network access request of the client 102. If the network access response message includes an EAP-Success message, the access device 104 accepts the network access request of the client 102. In the latter case, the client 102 is authenticated and the access device 104 allows it to access the network.

Once the client 102 is allowed to access the network, the client 102 can send network traffic to the access device 104. The access device 104 forwards the network traffic from the client 102 to the proxy service on the proxy network device 108. In response to receiving network traffic from the client 102, the proxy service identifies a GBP corresponding to the role information of the client 102. As mentioned earlier, a GBP refers to a list of roles and resources with which roles are to be provisioned. The resources can be hardware resources such as printers, scanners, or any other hardware device. The resources can also be software resources such as a SharePoint site, an intranet site, a firmware, or any other software (machine-executable instructions).

A GBP can define permissions and duration of access to a client 102 (or a user of the client 102). For example, a GBP can define a website(s) (e.g., YouTube) that a client 102 with a given role (e.g., an intern) is not allowed to access on the network. In another example, a GBP can define a hardware resource (e.g., printer, scanner, or fax machine) that a client 102 with a given role (e.g., a guest) is not allowed to access on the network. In a further example, a GBP can define a software resource (e.g., an internal SharePoint site) that a client 102 with a given role (e.g., an employee) is allowed to access on the network. In a like manner, there could be multiple GBPs that can be used to define roles and resources with which roles are to be provisioned.

In an example, GBPs corresponding to role information of clients (e.g., client 102) can be pre-configured on the proxy network device 108, for example, by a user (e.g., network administrator). In another example, GBPs corresponding to role information of clients (e.g., client 102) can be pre-configured on the authentication server 112, for example, by a user (e.g., network administrator). In the latter scenario, the proxy service can obtain a GBP(s) from the authentication server.

The proxy network device 108 includes a mapping between the MAC address and the role information of the client 102. The proxy service identifies the MAC address of the client 102 from the network traffic and determines the role information of the client 102 from the mapping stored on the proxy network device 108. The proxy service then identifies a GBP(s) corresponding to the role information of client 102. Once the GBP(s) is identified, the proxy service applies the GBP to the network traffic from the client 102. For example, if the GBP specifies not giving access to a specific website to the client 102, the proxy service would block access to the website for the client 102. In another example, if the GBP specifies not giving access to a specific hardware (e.g., a printer) to the client 102, the proxy service would block access to the hardware for the client 102.

In an example, a GBP can be used to segment client traffic in the network by grouping the clients (or users) into roles based on the client authentication. For example, a GBP can be used to segment “guest” client traffic to a VLAN, which could be separate from a VLAN used to segment “employee” client traffic.

In an example, the proxy service sends the mapping between the MAC address and the role information of the client 102 to the second proxy network device 110 (e.g., network switch or network router) on the network. This can be referred as syncing of “role-MAC mapping” between proxy network devices on the network. The syncing helps in policy enforcement across proxy network devices in various scenarios. For example, in case of a topology change event in the network (e.g., layer 2 network) one of the links to the proxy network device 108 can be blocked by Spanning Tree Protocol (STP), which is a network protocol that builds a loop-free logical topology for Ethernet networks. In such case, the network traffic from the client 102 can be received on the second proxy network device 110 using a redundant link. If the second proxy network device is synced with “role-MAC mapping” information from the proxy network device 108, a GBP corresponding to the role information can be applied to the client 102 even though the client 102 is no longer connected to the proxy network device 108.

To provide another example, syncing of “role-MAC mapping” helps in policy enforcement across proxy network devices in a roaming scenario if the client 102 (e.g., a mobile device) moves from a first AP (e.g., access device 104) to a second AP (e.g., second access device 106). After the client 102 moves to the second AP (e.g., second access device 106), network traffic from the client 102 is received on a separate proxy network device (e.g., second proxy network device 110) connected to the second AP. In an example, the second proxy network device 110 is synced with “role-MAC mapping” information from the proxy network device 108. Since the second proxy network device 110 now includes the role-MAC information of the client 102, the second AP can avoid sending an authentication request (e.g., a network access request message) to the authentication server (e.g., a RADIUS server) 112. If the second proxy network device 110 is not synced with role-MAC information of the client 102, the second AP may have to send an authentication request to the authentication server 112, which could be intercepted by a second proxy service on the second proxy network device 110 to learn the role-MAC information of the client 102. Since the latter process is avoided due to a prior role-MAC information syncing between the proxy network device 108 and the second proxy network device 110, a fast roaming of the client 102 takes place on the network.

Further, a GBP corresponding to the role information can be still applied to the client 102 even after the client 102 is no longer connected to the proxy network device 108. A second proxy service on the second proxy network device 110 can determine the role information of the client 102 from the role-MAC mapping on the second proxy network device 110. The second proxy service then identifies a GBP(s) corresponding to the role information of client 102. Once the GBP(s) is identified, the second proxy service applies the GBP(s) to the network traffic from the client 102.

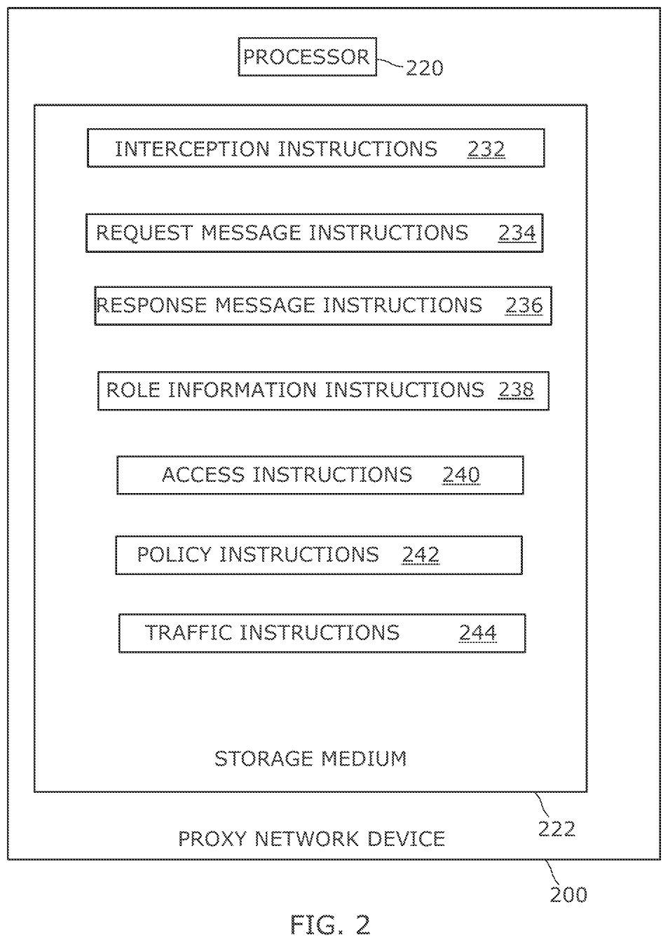

FIG. 2 illustrates a proxy network device 200 of the computing environment of FIG. 1, according to some examples. The proxy network device 200 can be analogous to the proxy network device 108 of FIG. 1, in which like reference numerals correspond to the same or similar, though perhaps not identical, and components. For the sake of brevity, components or reference numerals of FIG. 2 having the same or similarly described function in FIG. 1 are not being described in connection with FIG. 2. Said components or reference numerals may be considered alike.

The proxy network device 200 can include, for example, a network switch, a network router, or any other network device. In an example, the proxy network device 200 can include a processor 220 (or multiple processors) and a storage medium 222. The processor 220 can include a Central Processing Unit (CPU), a microprocessor, a programmable gate array, a microcontroller, or any other processing logic that interprets and executes machine-readable instructions stored in storage medium 222.

The storage medium 222 can store information and machine-readable instructions executable on the processor 220 to perform various tasks. The storage medium 222 can be Synchronous DRAM (SDRAM), Double Data Rate (DDR), Rambus DRAM (RDRAM), Rambus RAM, etc., or storage memory media such as a hard disk or any other storage device.

In an example, the processor 220 executes interception instructions 232 to intercept a network access request message pertaining to a client from an access device on a network (e.g., VXLAN). In an example, the client attempts to connect to the network via access device. In order to authorize the client's access to the network, an authentication mechanism is used. The authentication mechanism can be based on, for example, the 802.1X protocol or MAC authentication.

In an example, MAC authentication is used to authenticate the client based on client's physical MAC address. When the client connects to the access device, either by direct link or through the network, the access device forwards the client's MAC address to an authentication server for authentication. The authentication server uses the client's MAC address as the username and password, and grants or denies network access depending on whether the MAC address of the client matches with a pre-defined list of addresses.

In another example, in 802.1X authentication, the access device can detect the client and attempt to establish a connection. The access device creates a virtual port with the client and invokes EAP to send an EAP request message to the client.

In response to the EAP request message, the client sends an EAP response message to the access device. The response can include identification details (e.g., credentials or certificate) of the client. The access device receives the EAP response message. The access device maintains an IP address configuration for a proxy service on the proxy network device. In an example, the IP address configuration for the proxy service includes an Anycast IP address. In an example, the processor 220 executes interception instructions 232 to listen to network communication from the Anycast IP address configured on the access device to intercept messages (e.g., network access request message).

The proxy network device maintains a mapping of the Anycast IP address to an authentication server (e.g., a RADIUS server). The processor executes request message instructions to forward the network access request message to the authentication server (e.g., a RADIUS server). In an example, the network request message includes an EAP response message.

In response to the network access request packet, the authentication server can send a network access response message. The processor executes response message instructions to intercept the network access response message. In an example, the network access response message can include an EAP message. In an example, the network access response message can include role information of the client. The “role information” includes a role assigned to a client by the authentication server. In an example, the role assigned to a client is based on the identification details (e.g., credentials or certificate) provided by the client to the authentication server during the authentication process.

The network access response message can also include a MAC address of the client. In an example, the processor executes role information instructions to obtain the role information and the MAC address of the client from the network access response message. The role information instructions are executed to also map the MAC address of the client to the role information of the client. In an example, the role information instructions are executed to store the mapping between the MAC address and the role information of the client on the proxy network device.

The processor executes access instructions to send the network access response message, received from the authentication server, to the access device. In an example, the network access response message can include an EAP message. In an example, if the EAP message includes an EAP-Failure message, the access device denies the network access request of the client. If the network access response message includes an EAP-Success message, the access device accepts the network access request of the client. In the latter case, the client is authenticated and the access device allows it to access the network.

Once the client is allowed to access the network, the client can send network traffic to the access device. The access device forwards the network traffic from the client to the proxy network device. In response to receiving network traffic from the client, the processor executes policy instructions to identify a GBP corresponding to the role information of the client. In some examples, the GBP can include an access control list (ACL) of a firewall. The processor executes traffic instructions to apply the GBP to the network traffic from the client.

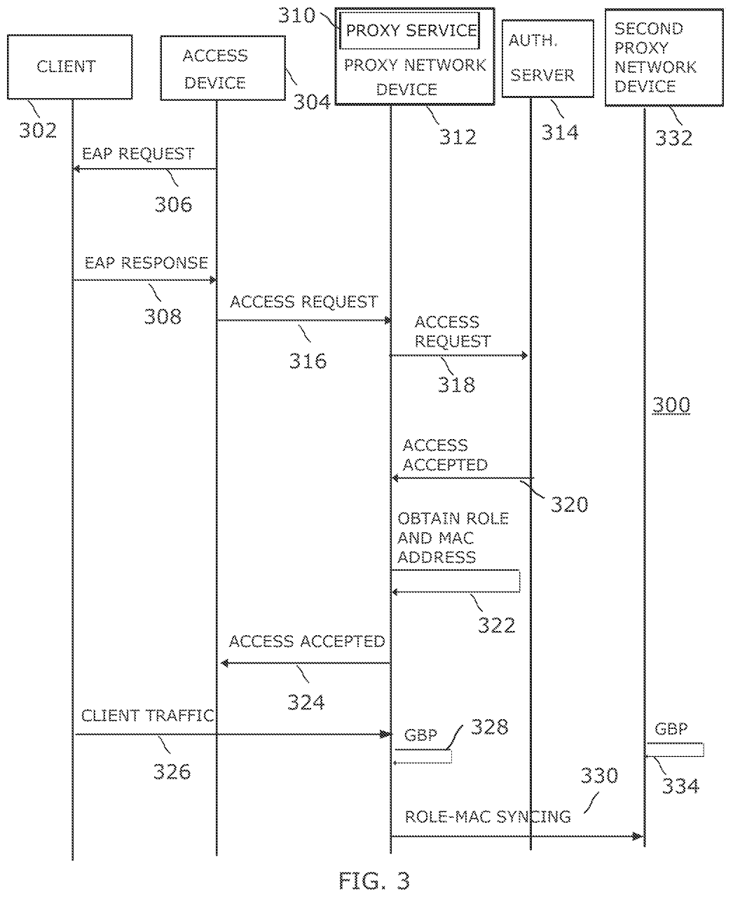

FIG. 3 is a block diagram of a communication flow 300, according to some examples. In FIG. 3, a client 302 attempts to connect to a network via access device 304. In order to authorize the client's 302 access to the network, an authentication mechanism is used. The authentication mechanism can be based on, for example, the 802.1X protocol or MAC authentication. For 802.1X authentication, the access device 304 can detect the client 302 and attempt to establish a connection. The access device 304 creates a virtual port with the client 302 and invokes EAP to send an EAP request message 306 to the client 302.

In response to the EAP request message 306, the client 302 sends an EAP response message 308 to the access device 304. The response can include identification details (e.g., credentials or certificate) of the client 302. The access device 304 receives the EAP response message 308. The access device 304 maintains an IP address configuration for a proxy service 310 on the proxy network device 312. In an example, the IP address configuration for the proxy service 310 includes an Anycast IP address. In an example, the proxy service 310 listens to network communication from the Anycast IP address configured on the access device 304 to intercept messages (e.g., network access request message) 316.

The proxy network device 312 maintains a mapping of the Anycast IP address to an authentication server (e.g., RADIUS server) 314. The proxy service 310 forwards the network access request message 318 to the authentication server (e.g., a RADIUS server) 314. In response to the network access request message 318, the authentication server 314 can send a network access response message 320 to the proxy network device. In an example, the network access response message can include an EAP message. In an example, the network access response message can include role information of the client 302.

The network access response message can also include a MAC address of the client 302. In an example, the proxy service 310 obtains 322 the role information and the MAC address of the client 302 from the network access response message. The proxy service 310 maps the MAC address of the client 302 to the role information of the client 302. In an example, the proxy service 310 stores the mapping between the MAC address and the role information of the client 302 on the proxy network device.

In another example, syncing of “role-MAC mapping” information among proxy network devices on the overlay network can be carried out by the proxy network device directly querying the authentication server (e.g., RADIUS server) when network traffic is received. An application programming interface (API) can be used for the proxy network device to communicate with the authentication server. Using the API, the proxy network device can obtain “role-MAC mapping” information from the authentication server.

The proxy service 310 sends 324 the network access response message, received from the authentication server 314, to the access device 304. If the network access response message includes an EAP-Success message, the access device 304 accepts the network access request of the client 302. In such case, the client 302 is authenticated and the access device 304 allows it to access the network.

Once the client 302 is allowed to access the network, the client 302 can send network traffic 326 to the access device 304. The access device 304 forwards the network traffic from the client 302 to the proxy network device. In response to receiving network traffic from the client 302, the proxy service 310 identifies a GBP corresponding to the role information of the client 302. The proxy service 310 applies the GBP 328 to the network traffic from the client 302. In an example, a second proxy network device 332 can be synced 330 with “role-MAC mapping” information from the proxy network device 312. If the client 302 roams on the network, a GBP 334 corresponding to the role information can be still applied to the client 102 (e.g., via second proxy network device 332) even though the client 102 is no longer connected to the earlier proxy network device 312.

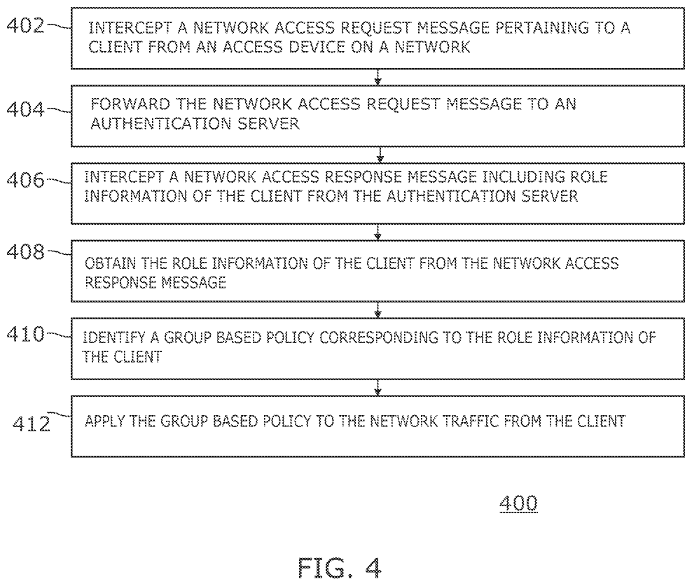

FIG. 4 is a flowchart of method 400, according to some examples. Method 400 can be performed by a network device including a processor, where the network device can include a network switch, a network router, or any other network device. For example, method 400 can at least partially be executed on the proxy network device 108 or 200 of FIG. 1 and FIG. 2, respectively.

At block 402, method 400 includes intercepting, by a proxy service on a proxy network device, a network access request message pertaining to a client from an access device on a network. In an example, the client attempts to connect to the network via the access device. In order to authorize the client's access to the network, an authentication mechanism is used. The authentication mechanism can be based on, for example, the 802.1X protocol or MAC authentication. For 802.1X authentication, the access device creates a virtual port with the client and invokes EAP to send an EAP request message to the client.

In response to the EAP request message, the client sends an EAP response message to the access device. The response can include identification details (e.g., credentials or certificate) of the client. The access device receives the EAP response message. The access device maintains an IP address configuration for a proxy service on the proxy network device. In an example, the IP address configuration for the proxy service includes an Anycast IP address.

In an example, the proxy service listens to network communication from the Anycast IP address configured on the access device to intercept messages (e.g., network access request message). At block 404, method 400 includes forwarding, by the proxy service on the proxy network device, the network access request message to an authentication server.

At block 406, method 400 includes intercepting, by the proxy service on the proxy network device, a network access response message including role information of the client from the authentication server. In an example, the network access response message can include an EAP message.

In an example, the network access response message can include role information and a MAC address of the client. At block 408, method 400 includes obtaining, by the proxy service on the proxy network device, the role information of the client from the network access response message. The proxy service maps the MAC address of the client to the role information of the client. In an example, the proxy service stores the mapping between the MAC address and the role information of the client on the proxy network device.

The proxy service sends the network access response message, received from the authentication server, to the access device. If the network access response message includes an EAP-Success message, the access device accepts the network access request of the client. In such case, the client is authenticated and the access device allows it to access the network. Once the client is allowed to access the network, the client can send network traffic to the access device. The access device forwards the network traffic from the client to the proxy network device.

At block 410, in response to receiving network traffic from the client, method 400 includes identifying, by the proxy service on the proxy network device, a GBP corresponding to the role information of the client. For example, a GBP can define a website(s) (e.g., YouTube) that a client with a given role (e.g., an intern) is not allowed to access on the network. In another example, a GBP can define a hardware resource (e.g., printer, scanner, or fax machine) that a client with a given role (e.g., a guest) is not allowed to access on the network.

At block 412, method 400 includes applying, by the proxy service on the proxy network device, the GBP to the network traffic from the client. For example, if the GBP specifies not giving access to a specific website to the client, the proxy service would block access to the website for the client. In another example, if the GBP specifies not giving access to a specific hardware (e.g., a printer) to the client, the proxy service would block access to the hardware for the client.

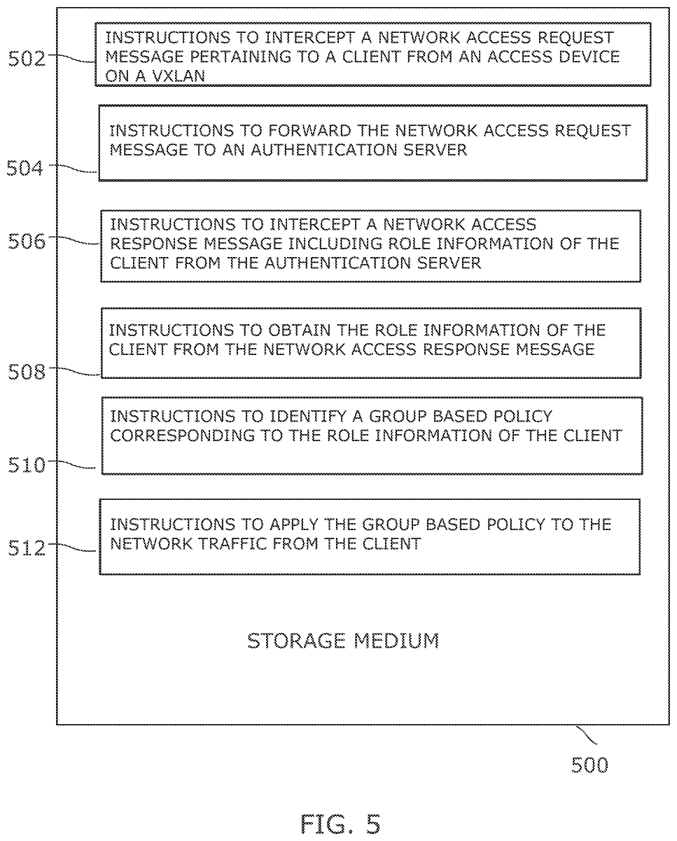

FIG. 5 is a block diagram of a non-transitory machine-readable or computer-readable storage medium 500 storing machine-readable instructions that upon execution cause a proxy network device to perform various tasks. The proxy network device can include a network switch, a network router, or any other network device.

The machine-readable instructions include instructions 502 that upon execution cause a proxy service on the proxy network device to intercept a network access request message pertaining to a client from an access device on a VXLAN. The machine-readable instructions include instructions 504 that upon execution cause the proxy service on the proxy network device to forward the network access request message to an authentication server.

The machine-readable instructions include instructions 506 that upon execution cause the proxy service to intercept a network access response message including role information of the client from the authentication server. The machine-readable instructions include instructions 508 that upon execution cause the proxy service to obtain the role information of the client from the network access response message. The machine-readable instructions include instructions 510 that upon execution cause the proxy service to identify a GBP corresponding to the role information of the client, in response to receiving network traffic from the client. The machine-readable instructions include instructions 510 that upon execution cause the proxy service to apply the GBP to the network traffic from the client.

For simplicity of explanation, the example method of FIG. 4 is shown as executing serially, however, it is to be understood and appreciated that the present and other examples are not limited by the illustrated order. The example systems of FIGS. 1, 2, 3, and 5, and the method of FIG. 4 may be implemented in the form of a computer program product including computer-executable instructions, such as program code, which may be run on any suitable computing device in conjunction with a suitable operating system (for example, Microsoft Windows®, Linux®, UNIX®, and the like). Examples within the scope of the present solution may also include program products comprising non-transitory computer-readable media for carrying or having computer-executable instructions or data structures stored thereon. Such computer-readable media can be any available media that can be accessed by a general-purpose or special-purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general-purpose or special-purpose computer. The computer-readable instructions can also be accessed from memory and executed by a processor.

It should be understood that the above-described examples of the present solution are for illustration. Although the solution has been described in conjunction with a specific example thereof, numerous modifications may be possible without materially departing from the teachings and advantages of the subject matter described herein. Other substitutions, modifications, and changes may be made without departing from the spirit of the present solution. The features disclosed in this specification (including any accompanying claims, abstract, and drawings), and/or the steps of any method or process so disclosed, may be combined in any combination, except combinations where at least some of such features and/or steps are mutually exclusive.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on one claim, the disclosure of various implementations includes each dependent claim in combination with every other claim in the claim set.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

As used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Also, as used herein, the terms “has,” “have,” “having,” or the like are intended to be open-ended terms. As used herein, the term “includes” is intended to mean “includes but not limited to”, and the term “including” is intended to mean “including but not limited to”. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method comprising:
intercepting, by a proxy service on a proxy network device, a network access request message pertaining to a client from an access device on a network;
forwarding, by the proxy service on the proxy network device, the network access request message to an authentication server;
intercepting, by the proxy service on the proxy network device, a network access response message including role information of the client from the authentication server;
obtaining, by the proxy service on the proxy network device, the role information of the client from the network access response message; and
in response to receiving network traffic from the client:
identifying, by the proxy service on the proxy network device, a group based policy (GBP) corresponding to the role information of the client; and
applying, by the proxy service on the proxy network device, the group based policy to the network traffic from the client.

2. The method of claim 1, wherein intercepting the network access request message comprises listening to network communication from an Anycast IP address configured on the access device.

3. The method of claim 1, wherein the network access response message includes a Media Access Control (MAC) address of the client.

4. The method of claim 3, further comprising:
obtaining, by the proxy service on the proxy network device, the MAC address of the client from the network access response message;
mapping, by the proxy service on the proxy network device, the MAC address of the client to the role information of the client; and
storing, by the proxy service on the proxy network device, the mapping between the MAC address with the role information of the client.

5. The method of claim 4, further comprising:
sending, by the proxy service on the proxy network device, the mapping between the MAC address and the role information of the client to a second access device, wherein the GBP corresponding to the role information of the client is applied to the network traffic received on the second access device from the client.

6. The method of claim 5, wherein the access device and the second access device are access points (APs).

7. The method of claim 1, wherein intercepting the network access request message comprises intercepting an Extensible Authentication Protocol (EAP) response message of the client.

8. The method of claim 1, wherein intercepting the network access response message comprises intercepting a network access acceptance message from the authentication server.

9. The method of claim 1, wherein obtaining comprises receiving, by the proxy service on the proxy network device, the GBP from the authentication server.

10. The method of claim 1, wherein the proxy service is a Remote Authentication Dial-In User Service (RADIUS) proxy service and the authentication server is a RADIUS server.

11. The method of claim 1, wherein the GBP corresponding to the role information of the client is present on the proxy network device.

12. A proxy network device comprising:
a processor; and
a non-transitory storage medium storing instructions that, when executed by the processor, cause the proxy network device to:
intercept a network access request message pertaining to a client from an access device on a network;
forward the network access request message to an authentication server;
intercept a network access response message including role information of the client from the authentication server;
obtain the role information of the client from the network access response message; and
in response to receiving network traffic from the client:
identify a group based policy (GBP) corresponding to the role information of the client; and
apply the group based policy to the network traffic from the client.

13. The proxy network device of claim 12, wherein the proxy network device is further to intercept the network access request message sent from the access device to the authentication server.

14. The proxy network device of claim 12, wherein the proxy network device is further to listen to network communication from an Anycast IP address configured on the access device to intercept the network access request message.

15. The proxy network device of claim 12, wherein the network comprises a Virtual Extensible Local Area Network (VXLAN).

16. A non-transitory machine-readable storage medium comprising instructions that upon execution cause a proxy network device to:
intercept, via a proxy service on the proxy network device, a network access request message pertaining to a client from an access device on a VXLAN;
forward, via the proxy service on the proxy network device, the network access request message to an authentication server;
intercept, via the proxy service on the proxy network device, a network access response message including role information of the client from the authentication server;
obtain, via the proxy service on the proxy network device, the role information of the client from the network access response message; and
in response to receiving network traffic from the client:
identify, via the proxy service on the proxy network device, a group based policy (GBP) corresponding to the role information of the client; and
apply, via the proxy service on the proxy network device, the group based policy to the network traffic from the client.

17. The non-transitory machine-readable storage medium of claim 16, further comprising instructions to:
obtain, via the proxy service on the proxy network device, a MAC address of the client from the network access response message;
map, via the proxy service on the proxy network device, the MAC address of the client with the role information of the client; and
store, by the proxy service on the proxy network device, the mapping between the MAC address and the role information of the client.

18. The non-transitory machine-readable storage medium of claim 17, further comprising instructions to:
send the mapping between the MAC address and the role information of the client to a second access device, wherein the GBP corresponding to the role information of the client is applied to the network traffic received on the second access device from the client.

19. The non-transitory machine-readable storage medium of claim 18, further comprising instructions to send the mapping between the MAC address and the role information of the client via a VXLAN.

20. The non-transitory machine-readable storage medium of claim 16, further comprising instructions to authenticate the access device through the authentication server prior to forwarding the network access request message to the authentication server.
